(19) United States
(12) Patent Application Publication
(10) Pub. No.: US 2016/0214316 A1
(43) Pub. Date: Jul. 28, 2016

(54) 3D printing method that generates fine asperity on solid surface

(71) Applicant: Yasusi Kanada, Tokyo (JP)

(72) Inventor: Yasusi Kanada, Tokyo (JP)

(21) Appl. No.: 15/004,892

(22) Filed: Jan. 23, 2016

(30) Foreign Application Priority Data
Jan. 25, 2015 (JP) 2015-011881

(51) Int. Cl. B29C 67/00

(52) U.S. Cl. CPC B29C 67/0055; B29C 67/0088; B29K 2105/0058

(57) ABSTRACT

The problems to be solved by this invention is that, by using a layering 3D printing, is to generate objects with fine asperity on the surface, especially with images or characters drawn by fine asperity in high speed and exactly. The method in this invention solves the problem that asperity part may be easily dropped off, that the shape of the drawn images or characters is inexact, that the asperity part of the filament is stringy, and that the direction of slicing is restricted.

The problems are solved by the following method. Solids with fine asperity on the surface can be generated in high speed and exactly by changing the cross section of filament by changing the print-head motion speed or by changing the filament extrusion speed. Especially, solids with images and characters on the surface represented by asperity by changing the cross section according to a bitmap of images or characters.

### BACKGROUND OF THE INVENTION

Basic technology of 3D printers of so-called fused-deposition-modeling type, which use ABS resin or PLA resin filament, is described in the U.S. Pat. No. 5,136,515 by Richard Helinski. In addition, there are other types of 3D printers that use material that is in gel-state in room temperature but becomes solid by heat or light. Moreover, there are selective laser sintering (SLS) or selective laser melting (SLM) type printers, which forms solids in similar ways as layering filaments (thus the material can be regarded as filament) by sintering or melting powder of metal or similar material. By using such technologies, object models to be printed are sliced to thin layers, and each layer is formed by arraying filament horizontally, and the layers are stacked.

By using above 3D printers, the following two methods can be used for creating solids with asperity or convex and concave on the solid surface. The first method is to create asperity part of the solid by printing it as another layer. This method can be embodied by slicing the solid along the surface direction. The second method is to create asperity by moving the print head, which extrudes filament, along the asperity. This method can be embodied by slicing the solid orthogonal to the solid surface.

### BRIEF SUMMARY OF THE INVENTION

### Problems to be Solved by this Invention

The purpose of this invention is to create objects that has fine asperity on the surface, especially, images or characters on the surface by high-speed and precise reduced-cost layered 3D printing. By the above first method, because asperity parts are printed as different layers, the asperity part is easy to be unstuck from the object.

In addition, there is a problem that the shape becomes imprecise or the head pulls a string at the end of the asperity, i.e., at the beginning or end of printing. Such phenomena tend to occur frequently because filament easily shorts at the beginning of printing and easily becomes superfluous at the end of printing. Moreover, there is another problem that, to apply this method, it is necessary to make the slicing direction along the solid surface, so the slicing direction is restricted.

In addition, in the second method described above, it is necessary to vary the print-head motion direction by a small amount to generate asperity. The restriction caused by this change of the slicing direction, the filament tends to become superfluous and the shape tends to be imprecise. Moreover, the slicing direction must be approximately orthogonal to the surface with asperity, and this causes a problem that the slicing direction is restricted.

Moreover, because both methods cause a restriction on the slicing direction, a problem that it is difficult to generate asperity on a free curved surface.

The above problems are the problems to be solved by this invention.

### Means to Solve the Problems

To solve the above problems that creating objects with fine asperity on the surface in high speed and exactly by using a layered 3D printing, the asperity should be created by varying the cross section of the filament. A convex is generated when the cross section is increased, and a concave is generated when the cross section is decreased. Concerning a 3D printer, the print-head motion direction and moving velocity can be controlled, and the extrusion speed of filament can be controlled. Therefore, to vary the cross section of the filament, either the extrusion speed of the filament or the head motion velocity is to be varied. If the filament extrusion speed is increased while the print-head motion speed is constant, then the cross section is decreased. If the extrusion speed is reduced while the print-head motion speed is constant, then the cross section is increased. Moreover, the cross section can be controlled by controlling both the print-head motion speed and the extrusion speed of the filament.

In particular, by scanning a bitmap of images and/or characters and varying the cross section according to the bitmap, a solid with asperity that express the images and/or characters on the surface can be created.

By the method of this invention described above, first, because the asperity part is not formed by a separate layer, the asperity does not become unstack; this may occur in the first conventional method. Second, because the asperity part is printed continuously in this method, printing does not become inaccurate at the end of the asperity part; this may occur in the first conventional method. Third, because it is not necessary to change the head motion direction quickly and repeatedly, printing does not become imprecise by fluctuation of extrusion speed caused by head-motion speed changes; this may occur in the second conventional method. Forth, because the asperity can be generated both when the slicing direction is along the object surface and when it is orthogonal to the object surface, and even when it is skewed, it rarely restricts the slicing direction. Fifth, because restrictions on the printing direction are not much, it is possible to generate asperity on free curved surfaces by this method.

### The Effect of this Invention

When creating a solid by using a 3D printer, by varying the cross section of filament extruded by the print head, this method enables creating objects with fine asperity on the surface, especially with images and characters on the surface, exactly and in high speed.

### BRIEF DESCRIPTION OF DRAWINGS

FIG. 1 explains the flow of modeling and 3D printing in the embodiment of this invention.

FIG. 2 explains the basic peeled model in the embodiment of this invention.

FIG. 3 explains the first peeled model, which is used in the deformation and transformation processing 104, in the embodiment of this invention.

FIG. 4 explains the method of transformation (modulation) of peeled model using a bitmap in the embodiment of this invention.

FIG. 5 explains the method of creating a globe in which lands and seas are expressed by asperity on the surface of the globe in the embodiment of this invention.

FIG. 6 explains the direction of print head when printing in the embodiment of this invention.

### DETAILED DESCRIPTION OF THE INVENTION (EMBODIMENT)

[Procedure of Modeling and 3D-Printing]

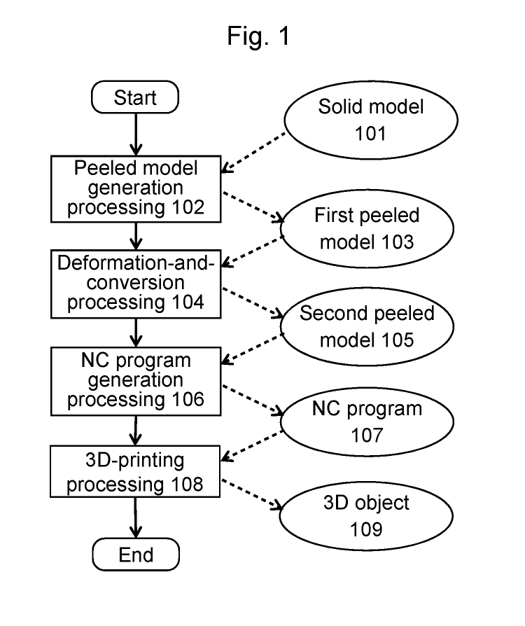

The outline of the procedure of 3D modeling and 3D printing that enables printing along any 3D direction by moving the head and nozzle of the 3D printer is explained using FIG. 1. The details of the steps and the model are explained later. First, model 101 is inputted, the peeled model generation processing 102 is executed, and the first peeled model 103 is generated as the result. Then, model 103 is inputted, the deformation and transformation processing 104 is executed, and the second peeled model 105 is generated as the result. In each peeled model, a solid is representing by stacked strings, and the cross sections and printing speeds of the representation points are specified. In the deformation and transformation processing 104, the solid can be deformed by transforming the coordinates of the representing points, and asperity on the object surface can be generated by specifying and varying the cross sections of the string. By executing NC program generation processing 106 which transforms the strings to an NC program that scans the strings specified in the second peeled model 105. The program extrudes filament for each string. The amount of the filament is in proportion to the cross section of the string, NC program 107 described by G-Code is generated. NC program 107 is inputted to a 3D printer, and executing 3D printing processing 108, 3D object 109 is obtained.

In addition, peeled model 103 and peeled model 105 can be described by G-Code. In this case, NC program generation processing 106 can be omitted. (This processing can be an identical transformation.)

[Peeled Model and Deformation and Transformation of Peeled Model]

Peeled model and a method for generating it from a solid model are described in the following patent application document 2 below. Peeled model generation processing is called “slicing processing” in this document and it is also called “hashing” in the non-patent document 1 below.
[Patent application document 2] US2015-0039113, Method and apparatus for 3D printing along natural direction
[Non-patent document 1] Kanada, Y., “Method of Designing, Partitioning, and Printing 3D Objects with Specified Printing Direction”, 2014 International Symposium on Flexible Automation (ISFA 2014), July 2014.

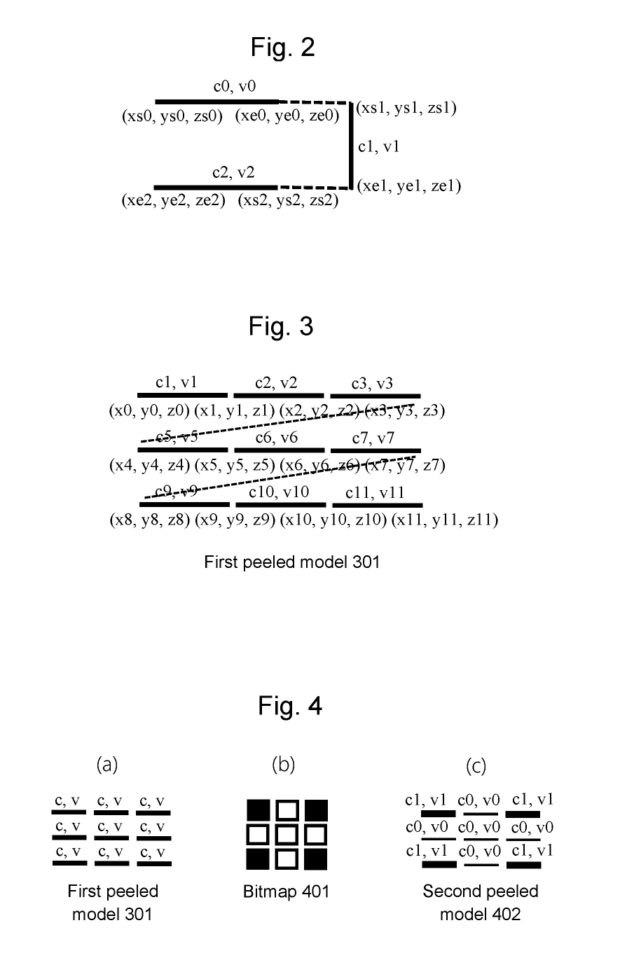

Peeled model, which is used in this embodiment, is explained using FIG. 2. A sequence of (short) straight strings can be used as a peeled model. In this case, each string can be represented by the start point coordinate (xsi, ysi, zsi), the end point coordinate (xei, yei, zei), and the cross section ci (i=0, 1, 2, in FIG. 2). When printing the object represented by the model, it is necessary to specify the head motion speed, so the printing speed vi (i=0, 1, 2) can be included in the model. If the strings have an order and the end point of each string and the start point of the next string is the same, the coordinates of the start points of the strings except the first string can be omitted. So a peeled model can be represented as expression (1).

(x0, y0, z0), (x1, y1, z1, c1, v1), (x2, y2, z2, c2, v2), . . . , (xN, yN, zN, cN, vN) (1)

In the explanation below, it is assumed that each peeled model is represented by the form of (1).

Next, general processing required when a peeled model is deformed and transformed is explained. To deform and transform a peeled model 103, in deformation and transformation processing 104, a coordinate transformation function that transforms the above coordinate, a transformation function of cross section, and a transformation function of printing speed should be given. By using these functions, the peeled model 103, which represents an empty cylinder, can be deformed to peeled model 105, which represents an empty sphere, half sphere, or bowl. To preserve printability (to keep the object printable by a normal 3D printer), the cross section and the printing speed must be transformed according to the coordinate transformation, so transformation functions for these transformation can be specified in addition.

[Addition of Asperity on the Surface of Peeled Model]

To give asperity on the surface of peeled model, the cross section and the printing speed are varied depending on the part of object by giving a transformation function of the cross section and that of the printing velocity in the deformation and transformation processing 104. The method of giving asperity to a peeled model is explained below using FIGS. 3 and 4.

FIG. 3 shows the first peeled model 301 when N is equal to 11. Nine of the eleven short lines are arrayed on 3×3 grids on a plane. Grids can be placed either horizontal, vertical, or on a skewed plane. The cross sections and the printing speeds for these short lines are (c1, v1), (c2, v2), (c3, v3), (c5, v5), (c6, v6), (c7, v7), (c9, v9), (c10, v10), (c11, v11). In the first peeled model 301, these strings are equally printed, so all the cross sections are the same and all the printing speeds are to be also the same. However, the line between (x3, y3, z3) and (x4, y4, z4) and the line between (x7, y7, z7) and (x8, y8, z8) are supplementary (i.e., requires no filament), so the cross section c4 is assumed to be minimized (ideally zero) and the printing speed v4 is assumed to be maximized (ideally infinite).

In addition, in FIG. 3, the printing speed is specified to each line, but it is possible not to specify the printing speed in the first peeled model 301. If no printing speed is specified in a peeled model, the second peeled model 105 that has no specification of printing speed is inputted and the printing speed is generated in the execution of each command that corresponds to the line in the NC program generation processing 106, or the second peeled model 105 with printing speeds is generated in the deformation and transformation processing 104 by regarding that the first peeled model 103 that has no specification of printing speed is inputted and the printing speed in the first peeled model 103 as constant or by regarding a standard speed that is calculated from the conditions specified for the filament as specified.

In addition, although a cross section is specified to each line in FIG. 3, it is possible not to specify a cross section in the first peeled model 301. If no cross section is specified in a peeled model, in the deformation and transformation processing 104, the first peeled model 103, which specifies no cross-section values, is inputted, generating the second peeled model 105 by estimated cross-section values by regarding the cross section in the first peeled model is constant or by regarding that the standard cross-section values is calculated from the conditions specified to the filament.

In the process described above, the first peeled model 301 is an example of the first peeled model 103 shown in FIG. 1. For the first peeled model 103, not only equally-spaced grid arrangements on a plane but also equally- or non-equally-spaced grid arrangements on curved surfaces such as a cylinder or a sphere or 1D or 2D non-grid arrangements with any shapes can be used.

In FIG. 4, a procedure that modulates (adds concave and convex that correspond to the bitmap) the peeled model shown in FIG. 3 is outlined. FIG. 4(a) shows the first peeled model 301, which is arranged as a plain 3×3 grid without asperities. FIG. 4(b) shows a binary 3×3 bitmap 401, which is mapped to the first peeled model 301. FIG. 4(c) shows the second peeled model 402, which is generated by modulation (conversion) using bitmap 401. The second peeled model 402 is an example of the third peeled model 105 shown in FIG. 1.

The lines that correspond to white bits (i.e. zero) in bitmap 401 are assigned cross section c0 and printing speed v0, and the lines that correspond to black bits (i.e., one) in bitmap 401 are assigned cross section c1 and printing speed v1. If c0<c1, then the lines that correspond to white bits becomes concave and those correspond to black bits becomes convex. On the contrary, if c0>c1, then the lines that correspond to white bits becomes convex and those correspond to black bits becomes concave. If the difference between c0 and c1 is small or the ratio of c0 and c1 is close to 1, the asperity becomes small. On the contrary, if the difference between c0 and c1 is large or the ratio of c0 and c1 is far from 1, the asperity becomes large; however, if it the asperity is too large, the object shape may become collapsed or unprintable, so usually the ratio must be between 0.5 and 2.

In FIG. 4, a binary bitmap is used; however, multi-valued or continuous-valued (i.e., real-valued, float-valued) bitmap can be used. In such cases, the cross section and the printing speed of the second peeled model 402 become multi- or continuous-valued. If the bitmap is multi-valued, usually, the cross sections, c0, c1, c2, . . . , that correspond to the values of the bitmap, 0, 1, 2, . . . , should satisfy c0<c1<c2< . . . or c0>c1>c2> . . . . Moreover, if the bitmap is continuous-valued, normally, the cross-section function c(b) should be uniformly increasing or decreasing according to the bitmap value b. If the contrast of the asperity should be stronger or weaker than the bitmap 401, a non-linear function can be used for the cross-section function.

Printing speed is not precisely in proportion to the amount of asperity; however, to control the preciseness of asperity, printing speed is controlled by changing the head motion speed as explained below. To control the cross section, the filament extrusion speed or the head motion speed is to be controlled. However, normally, the response of the filament extrusion speed is slow. So, if the filament extrusion speed is changed, the printing speed must be extremely slow to generate exact asperity. In contrast, the head motion speed responds quickly to control. Therefore, to print in high speed, the filament extrusion speed should be constant and only the head motion speed should be changed for controlling the cross section. This enables high-speed printing of objects with asperity using an FDM-type 3D printer, i.e., at more than 30 mm/sec. To do so, the G-Code program that controls the FDM-type printer, when printing by using G1 command from point (x0, y0, z0) to point (x1, y1, z1), both the head motion speed and the amount of input filament are specified by the G-Code program; that is, the input filament is controlled to make the filament extrusion speed constant while changing the head motion speed.

Next, the print-head direction in the 3D printing process 108 is explained using FIG. 6. If the print head is orthogonal to the surface of the 3D object 109, the tip of the head prevents generation of asperity. Thus, if the direction of the print head can be selected, as shown in FIG. 6(a), the print head is directed to orthogonal to the surface 601 of the 3D object 109 or to a skewed direction 603. As shown in FIG. 6(b), asperity is generated on both sides of the filament when the 3D object 109 is generated by a single-layer filament. That is, this type of printing method can be used for generating asperity on both sides of thin 3D object 109.

In addition, to generate asperity on the surface of a printed object, the method of this invention and a conventional method in which the head is moved along the asperity can be combined. That is, if the motion speed decreases more than the desired value by quickly changing the head motion speed, the direction change can be relatively slow and excess or shortage of filament caused by the direction change can be made compensated by changing the head motion speed without changing the filament extrusion speed. Especially, when generating vertical asperities on a horizontal surface and when the print-head direction cannot be changed, generating asperities only by using the method described above may be prevented. However, in this case, if the print head is lifted, asperities can be generated as expected. By combining the method of this invention and a conventional method to compensate weak points, more exact asperities can be generated.

[Creating a Globe]

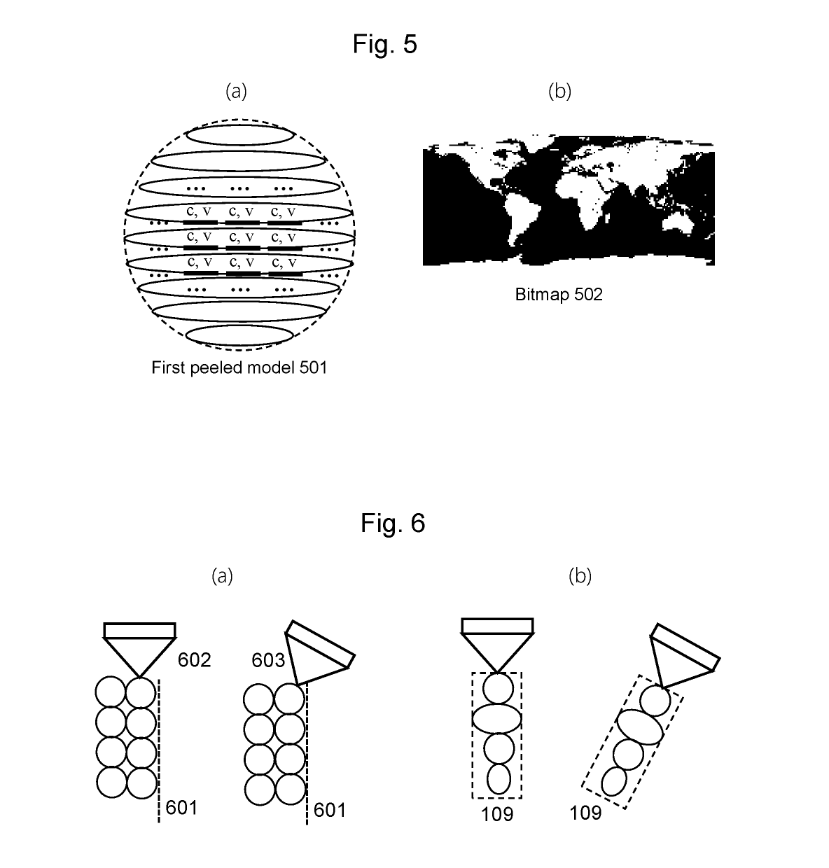

A globe can be created by mapping a map of equidistant cylindrical projection on a sphere. The method is explained using FIG. 5. As shown in FIG. 5(a), a sphere formed by stacking 180 circular filaments vertically is used for the first peeled model 501. This means, the diameters of lower 90 circles increases with the increasing height, but the diameters of upper 90 circles decreases with the increasing height. Each circle is divided to 360 arcs (i.e., by 1 degree), and each arc is approximated by a straight line. The coordinate of the start point of each line coincide with that of the end point of the previous line. To print these circles smoothly, each circle is slightly deformed and connected to the neighbor circles, and they form a type of helix. The bitmap is mapped to this helix.

A map of equidistant cylindrical projection, which is represented by a bitmap, is used for the bitmap 502. FIG. 5(b) shows a binary-valued map; however, multi-valued or real-valued map can also be used. The size of the bitmap of equidistant cylindrical projection is 2×1; that is, the number of pixels along the longitude direction is twice as large as that along the latitude direction. For example, a map with 360×180 pixels can be prepared for the mapping. This size of map can be mapped to a globe that consists of fragments (lines) with one-degree (horizontal) by one-degree (vertical). If a smaller degree is used for the fragment, a more precise map can be printed.

The second peeled model can be obtained by converting the first peeled model 501 using the bitmap 502. If the bitmap 502 is binary-valued, a globe with convex lands and concave seas or a globe with concave lands and convex seas is generated.

However, near a pole of the globe, filament division by one degree is too fine. One-degree string is too short compared with the precision of the print head and the size of the print head. It makes printing less efficient, and it may make the motion of the 3D printer unstable. Thus, multiple contiguous strings are to be replaced by a string with a representative (average) value; that is, the strings are to be thin out or to be averaged, and print them per five degrees, for example. This enables more efficient and more stable printing.

When creating a globe or printing a map, the following effect can be obtained by this invention. That is, by adding asperities, the globe becomes available to visually-impaired persons. By adding asperities, the globe becomes available for visually-impaired persons. In addition, by varying the filament cross-section, not only asperities are added, but also reflection of lands and that of seas can be made distinctive and artistic. These effects may be caused not only by a globe but also by a map on a plane or other types of curved maps, such as moon globe or maps on more complex curved surface.

[Printing Characters and Braille]

By using normal or braille characters for the bitmap 401 or 502 instead of images, pods, cases, or plates with characters or braille on the surface can be created. Binary valued bitmaps are suited for this purpose. Texts or calendars can be created by sequencing characters or braille of dot matrices. Because the size of braille characters is standardized, the cross section of filament should be designed to generate them. The size of dots in a braille is a little less than 1.5 mm, and the intervals of braille characters is a little less than 2.5 mm. So, if the pitch (i.e., the length and width of lines), P, is a little less than 0.5 mm and the size of a braille character is 3*P and the interval is 5*P, braille characters of an appropriate size are obtained.

In addition, to make the print pitch a little less than 0.5 mm, the nozzle diameter of the print head must be sufficiently smaller than 0.5 mm. Moreover, when moving the print head up or down when printing, if the tip of the print head has horizontal part (i.e., part orthogonal to the nozzle hole direction), the diameter must be much smaller than 0.5 mm. To use such a print head with small tip, the designed shape of extruded filament must be preserved without deformed to an unexpected shape.

What are claimed are:

1. A method of 3D printing, which forms a solid by layering extruded filaments extruded by the print head of a 3D printer;
comprising a process of generating asperity on the surface of said solid by increasing or decreasing the cross section of the filament on said surface by increasing or decreasing the motion speed of said print head.

2. A method of 3D printing according to claim 1; wherein said process generates said asperity on the surface of the solid while keeping the filament feed rate constant.

3. A method of 3D modeling and printing; comprising steps
a) a deformation and translation process that inputs the first model, which represents a solid that is formed by stacking filament, and that performs transformation of said first model to the second model, which represents a solid that is created by stacking filament with specified cross section,
b) a NC program generation process that translates said second model to an NC program that can be processed by a 3D printer, and
c) a 3D printing process that sends said NC program to said 3D printer and generating a printed solid;
wherein asperity of the surface of the said printed solid formed in said step c) is controlled by said transformation of increasing or decreasing the specified or estimated cross section of the first filament part of said first model to generate the second filament part of said second model in step a),
wherein said cross section determines the cross section of the corresponding part of said printed solid in step c).

4. A method of 3D modeling and printing according to claim 3;
wherein the second printing speed can be specified to said second model in step a), and
wherein said cross section in said step a) is increased or decreased by generating said second printing speed by said transformation of increasing or decreasing the first printing speed of said first filament part specified by estimating said second printing speed from said first model, to generate said second filament part of said second model, and
wherein said second printing speed is copied to the printing speed specified in said NC program in step b).

5. A method of 3D modeling and printing according to claim 3;
wherein said asperity on the surface of said printed solid is generated in said step a) by associating said first filament part with part of said bitmap in said transformation and by calculating the cross section of said second part of filament according to the amount of bitmap-part value.

6. A method of 3D modeling and printing according to claim 5;
wherein a binary-valued bitmap is used for said bitmap in said step a) and
said asperity on the surface of said solid is a binary asperity.

7. A method of 3D modeling and printing according to claim 5;
wherein a multi-valued bitmap is used for said bitmap in said step a) and
said asperity on the surface of said solid is multi-valued asperity with three or more different degrees of asperity.

8. A method of 3D modeling and printing according to claim 5;
wherein a real-valued bitmap is used for said bitmap in said step a) and
said asperity on the surface of said solid is real-valued asperity with continuous degrees of asperity.

9. A method of 3D modeling and printing according to claim 5;
wherein the shape of said first model in said step a) is a sphere, and
wherein said second model with a map drawn by asperity on the surface of said sphere is generated in said step a) by transforming said first filament part to said second filament part, which forms a sphere, by mapping a map to said first filament part.

10. A method of 3D modeling and printing according to claim 9;
wherein said map is a world map, and
wherein said sphere represents a globe with lands and seas represented by asperity on the surface of said sphere.

11. A method of 3D modeling and printing according to claim 9;
wherein said map is a bit-mapped world map based on equidistant cylindrical projection,
wherein said first filament part consists of parts, each of which is mapped to a part of said map that represents a certain range of latitude and certain range of longitude
and each bit of said bit-mapped world map is mapped to the cross section of each part of said second filament part.

12. A method of 3D modeling and printing according to claim 11;
wherein in the case that said first filament part becomes much smaller than the size of the print-head control mechanism and the size of the tip of the print head in said step a);
wherein said step a) further comprises a process of mapping multiple parts of said first filament part are mapped to said solid second filament part, and
wherein the cross section value of said second filament part is calculated from the cross section values of said multiple parts of the first filament part.

13. A method of 3D modeling and printing according to claim 5;
wherein a string of characters that are represented by dot matrices is used for said bitmap, and
wherein asperity that represent said characters on the surface of said solid model that is generated in said step a).

14. A method of 3D modeling and printing according to claim 5;
wherein a sequence of braille characters are represented by asperity on the surface of said solid by using one or two dimensional array of braille characters represented by dot matrices for said bitmap.
